(19) United States
(12) Patent Application Publication
(10) Pub. No.: US 2001/0045995 A1
(43) Pub. Date: Nov. 29, 2001

(54) LIQUID CRYSTAL DISPLAY AND MANUFACTURING METHOD THERFOR

(76) Inventors: YOSHINORI NUMANO, TOKYO (JP); KAZUHIRO KOBAYASHI, TOKYO (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 08/865,071

(22) Filed: May 29, 1997

(30) Foreign Application Priority Data
Nov. 13, 1996 (JP) 8-301445

(51) Int. Cl. G02F 1/1343

(52) U.S. Cl. 349/38

(57) ABSTRACT

A liquid crystal display including an insulating substrate, a plurality of gate electrodes, a common line for auxiliary capacitance arranged between adjacent gate electrodes, said common line being formed on the insulating substrate and the adjacent gate electrodes, at least one layer of semiconductor material film formed so as to cover at least one portion of the gate electrodes through the gate insulating film formed on the insulating substrate, a source region and a drain region formed in the semiconductor material film, a pixel electrode formed on the gate insulating film and formed to cover the common line, an electrode for capacitance to be connected with the pixel electrode and formed to superpose one portion on the adjacent gate electrode, and a source and a drain electrode provided respectively on the source region and the drain region.

### BACKGROUND OF THE INVENTION

The present invention relates generally to an active matrix liquid crystal display and a method of manufacturing the same, and to its thin film transistor.

Active matrix liquid crystal displays are developed with the thin film transistor using amorphous Si semiconductor as switching elements (hereinafter referred to as TFT), being formed in matrix shape on the insulating substrate such as glass or the like. In the active matrix liquid crystal display, distortion of applied voltage to the liquid crystal is generated through the parasitic capacity (hereinafter referred to as Cgd) which is caused by the superposition between the gate electrode and the drain electrode of the TFT. The DC bias is applied on the liquid crystal because the distortion of applied voltage to the liquid crystal is varied by the capacity change accompanied by the anisotropy of dielectric constant of the liquid crystal. The liquid crystal is required to be driven by AC. The liquid crystal is deteriorated with application of the DC bias, causing the deterioration of the display characteristics such as flicker, residual images and so on.

It is necessary to make influences of Cgd smaller by parallel addition of the load capacitance on the capacitance of the liquid crystal. There have been two methods to apply parallel addition of the load capacitance on the liquid crystal. One method is using common line (hereinafter referred to as CS-on-common structure), and the other is a method using overlapping of the pixel electrode on the previous gate line (hereinafter referred to as CS on-gate structure).

FIG. 12 is a plan view showing one pixel of the CS-on-gate structure TFT-LCD reported at, for example, the Technology Report Meeting, Electronic Information Communication Society, 1990, (EID90-13). FIG. 13 is a sectional view taken along a line A-A′ showing the method of making it.

In the drawing, reference numeral 1 is a glass substrate (FIG. 12), reference numeral 2 is a gate electrode formed on the glass substrate 1, reference numeral 4 is a gate insulating film (FIG. 12) formed on the glass substrate 1 including the gate electrode 2, reference numeral 5 is an amorphous silicon formed on the gate electrode 2 through the gate insulating film 4, reference numeral 6 is n+ amorphous silicon (FIG. 12) with PH₃ being doped into it, formed on the amorphous silicon 5, forming a source drain region, reference numeral 7 is a pixel electrode whose part being superposed, on the gate electrode 2 of one line before the line of the gate electrode, reference numeral 8 is source line, extended on the n+ amorphous silicon 6, provided on the gate insulating film 4, reference numeral 9 is a drain electrode provided across the pixel electrode 7, the n+ amorphous silicon 6 and the gate insulating film 4, reference numeral 10 is a passivation layer (FIG. 12) provided on the entire face of the glass substrate plate 1.

A method of manufacturing such a conventional liquid crystal display as described above will be described hereinafter with the use of FIG. 13. A gate electrode 2 is formed (FIG. 13(A)) on the glass substrate 1. Then, the gate insulating film 4, the amorphous silicon 5, the n+ amorphous silicon 6 with P doped into it are successively deposited, and the amorphous silicon 5, the n+ amorphous silicon 6 with P doped into it are removed by etching with the necessary portion remaining (FIG. 13(B)).

Then, the pixel electrode 7 is formed (FIG. 13(C)) so that the pixel electrode 7 may be superposed on the gate electrode (n-1st) of one line before the line of the gate electrode. Then, the source line 8 and the drain electrode 9 are formed. Then, the n+ amorphous silicon 6 with P doped into it is removed with the portion necessary for forming the source region and the drain region of the TFT remaining (FIG. 13(D)). Finally, the passivation layer 10 is formed (FIG. 13(E)).

Also, FIG. 14 is a plan view showing one pixel of a CS common line system TFT-LCD reported in the same documents. FIG. 15 is a sectional view taken along a line A-A′ showing the manufacturing method thereof. In the drawing, reference numerals 1 through 10 are the same as those of FIG. 12 and FIG. 13. Reference numeral 11 is a common line arranged between the adjacent gate electrodes, with the pixel electrode 7 being provided to cover the common line 11.

The manufacturing method will be described hereinafter in accordance with FIG. 15. The common line 11 is formed, simultaneously with the gate electrode 2, on the glass substrate 1 (FIG. 15(A)). Then, the gate insulating film 4, the amorphous silicon 5, the n+ amorphous silicon 6 with the P doped into it are successively deposited, and the amorphous silicon 5, the n+ amorphous silicon 6 with the P doped into it are removed by etching with necessary portion remaining (FIG. 15(B)). Then, the pixel electrode 7 is formed so as to cover the common line 11 (FIG. 15(C)). The description thereof will be omitted, because it is same in steps as the CS-on-gate structure.

The conventional TFT-LCD is composed as described above. The capacity is formed with the gate electrode 2 of one line before the line of the gate electrode being superposed on the pixel electrode 7 in the case of the CS-on-gate system. Thus, the load capacity of the gate electrode 2 becomes larger.

In the gate electrode 2, the signal becomes as short as approximately 10 μsec when the precision of the picture face is XGA although the signal as short as approximately 50 μsec has only to be transmitted when the precision of the picture face is VGA. Accordingly, the delay time of the signal to be transmitted is demanded to as short as approximately few μsec or lower. Therefore, in the CS-on-gate structure, the width of the gate electrode 2 is required to be widened to make the delay time of the gate signal short, because the load capacitance of the gate electrode 2 is large. The gate line portion does not allow the light to pass through it, because the gate electrode 2 normally uses opaque metal films of, for example, Cr, Al, Ta, Mo, or films laminated or alloyed with them. Accordingly, the aperture ratio of the TFT-LCD is decreased. In the TFT-LCD, the using efficiency of the light is higher as the aperture ratio becomes larger, thus making it possible to reduce the consumption power. Namely, in the CS-on-gate structure, the gate line width becomes wider, and the consumption power increases as the aperture ratio is reduced, thus resulting in a problem.

In the CS-on-common structure, the load capacitance of the gate electrode 2 is small so that the line width can be made narrower, because the pixel electrode 7 are not superposed on the gate electrode 2. Also, in the CS-on-common structure, the sum of the gate line width and the common line width is made narrower than the gate line width in the CS-on-gate structure, because the delay time of the CS signal to be required for the common line 11 is longer than the delay time to be required for the gate signal. But in the case of the CS-on-common structure, the space between the pixel electrode 7 and the gate electrode 2 of one line before the line of the gate electrode was left. The light to be transmitted through the portion was not controlled, because the liquid crystal of the portion did not receive the influences of the electric field by the pixel electrode 7.

Thus, in the pixel electrode 7, the light was leaked from the pixel 7 and the gate electrode 2 of one line before the line of the gate electrode in spite of the black display.

To prevent it, it was necessary to form the film (hereinafter referred to as black mask (BM)) for shielding the light to be leaked from the portion on a color filter (hereinafter referred to as CF) for grasping the liquid crystal in such a manner as to be opposed to the glass substrate 1 for forming the TFT. The accuracy in the superposition between the glass substrate 1 and the CF substrate for forming the TFT was generally about 5 μm through 10 μm. To completely shield the light leaked from the space between the pixel electrode 7 and the gate electrode 2 of one line before the line of the pixel electrode, the BM was necessary to be further formed inwardly by a portion equivalent to the superposition accuracy from the end portion of the pixel electrode 7. Further, the aperture ratio was lowered, with a problem that the consumption power increased because of the reduction in the light utilizing efficiency.

Accordingly, a first object of the present invention is to obtain a liquid crystal display which is reduced in consumption power by making the aperture ratio larger while shorting the delay time of the gate signal.

Also, it is second object of the present invention to provide a method of manufacturing such a liquid crystal display.

### SUMMARY OF THE INVENTION

The liquid crystal display of the present invention comprises a common line for auxiliary capacity arranged among a plurality of gate electrodes formed on the insulating substrate and the adjacent gate electrodes, at least one layer of semiconductor material film formed so as to cover at least one portion of the gate electrodes through the gate insulating film formed on the insulating substrate, a source region and a drain region formed in the semiconductor material film, a pixel electrode formed on the gate insulating film and formed to cover the common line, an electrode for capacity to be connected with the pixel electrode and formed to superpose one portion on the adjacent gate electrode, and a source and a drain electrode provided respectively on the source region and the drain region.

Also, a pixel electrode formed on the insulating substrate, an electrode for capacity connected with the pixel electrode, and at least one layer of semiconductor material layer, a source region and a drain region formed on the semiconductor material layer, a gate insulating film formed on the insulating substrate, and a common line for auxiliary capacity arranged between the plurality of gate electrodes formed on the semiconductor material through the gate insulating film and the adjacent gate electrodes are provided, with the common line being arranged on the pixel electrode through the gate insulating film, and the electrode for capacity is formed so as to superpose one portion on the adjacent gate electrode through the gate insulating film.

Also, a semiconductor material film having a source region and a drain region formed on the insulating substrate, a gate insulating film formed to cover the top face and the side face of the semiconductor material film, a plurality of gate electrodes formed on the insulating substrate including the gate insulating film, a common line for auxiliary capacity to be formed on the insulating substrate and arranged between the adjacent gate electrodes, an insulating film formed on an insulating substrate including the on gate insulating film, the on gate electrode and the on the common line, a pixel electrode to be, formed on the insulating film and formed to cover the common line, an electrode for capacity to be formed on the insulating film and formed, and to be connected with the pixel electrode and formed to superpose one portion on the adjacent gate electrode.

Further, the electrode for capacitance is the extending of the pixel electrode.

Also, the gate electrode and the common line are made of the same material.

Further, the common line is made of a transparent material.

Also, the transparent material of the common line is made of a material which is 50% or more in transmission factor with respect to visual light and 500μΩ·cm or lower in specific resistance.

Also, the transparent material of the common line is made of either of indium tin oxide, tin oxide, indium phosphorus.

In addition, the transparent electrode is provided to cover the common line in contact with common line.

Also, the transparent electrode for covering the common line is made of a material of 50% or more in transmission factor with respect to the visual light, 500μΩ·cm or lower in specific resistance.

Also, the transparent material for covering the common line is made of either of indium tin oxide, tin oxide, indium phosphorus.

Further, the semiconductor material film is amorphous silicon film.

Also, the semiconductor material film is polycrystalline silicon film.

Also, a method of manufacturing a liquid crystal display of the present invention comprises a first step of forming a plurality of gate electrodes on the insulating substrate, a second step for forming the common line to be arranged between the adjacent gate electrodes, a third step of forming the gate insulating film on the insulating substrate including the on the gate electrode and the on the common line, a fourth step for forming the semiconductor material film of at least one layer, a fifth step of covering the common line through the gate insulating film, and also forming the pixel electrode so that one portion may be superposed on the adjacent gage electrode, a sixth step for forming the source region and the drain region by etching the semiconductor material film.

Further, the first step and the second step are carried out at the same time.

Also, the method including a seventh step of forming the transparent electrode so as to cover the common line.

The seventh step is carried out before the third step after the completion of the second step.

### BRIEF DESCRIPTION OF THE DRAWINGS

FIG. 1 is a plan view showing the TFT-LCD in accordance with Embodiment 1 of the invention;

FIGS. 2(A) to 2(E) are each sectional view showing the method of manufacturing the TFT-LCD in accordance with Embodiment 1 of the invention;

FIG. 3 is a plan view showing the TFT-LCD in accordance with Embodiment 2 of the invention;

FIGS. 4(A) to 4(E) are each sectional view showing the method of manufacturing the TFT-LCD in accordance with Embodiment 2 of the invention;

FIG. 5 is a plan view showing the TFT-LCD in accordance with Embodiment 3 of the invention;

FIGS. 6(A) to 6(E) are each sectional view showing the method of manufacturing the TFT-LCD in accordance with Embodiment 3 of the invention;

FIG. 7 is a plan view showing the TFT-LCD in accordance with Embodiment 4 of the invention;

FIGS. 8(A) to 8(E) are each sectional view showing the method of manufacturing the TFT-LCD in accordance with Embodiment 4 of the invention;

FIGS. 9(A) to 9(E) are each sectional view showing the method of manufacturing the TFT-LCD in accordance with Embodiment 5 of the invention;

FIGS. 10(A) to 10(E) are each sectional view showing the method of manufacturing the TFT-LCD in accordance with Embodiment 5 of the invention;

FIGS. 11(A) to 11(E) are each sectional view showing the method of manufacturing the TFT-LCD in accordance with Embodiment 6 of the invention;

FIG. 12 is a plan view showing conventional CS-on-gate structure TFT-LCD;

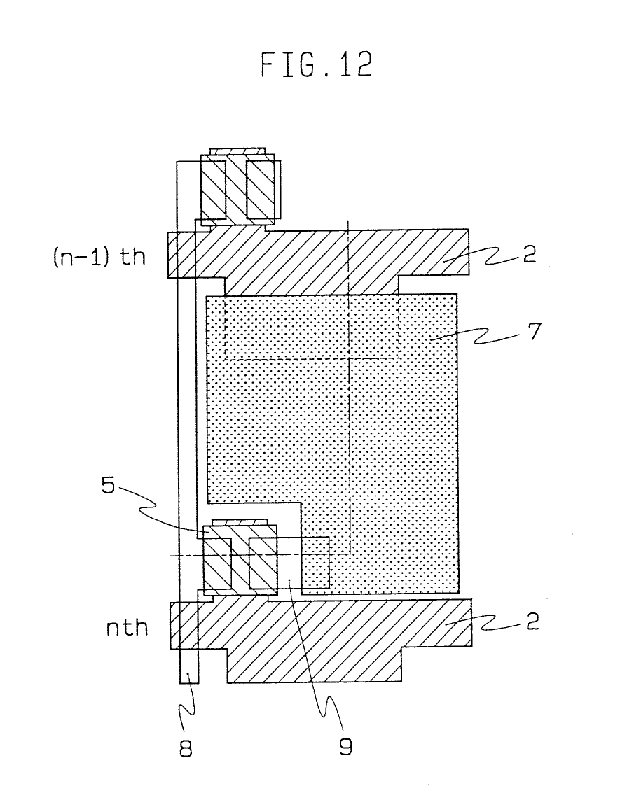

FIGS. 13(A) to 13(E) are each sectional view showing the method of manufacturing the conventional CS-on-gate structure TFT-LCD;

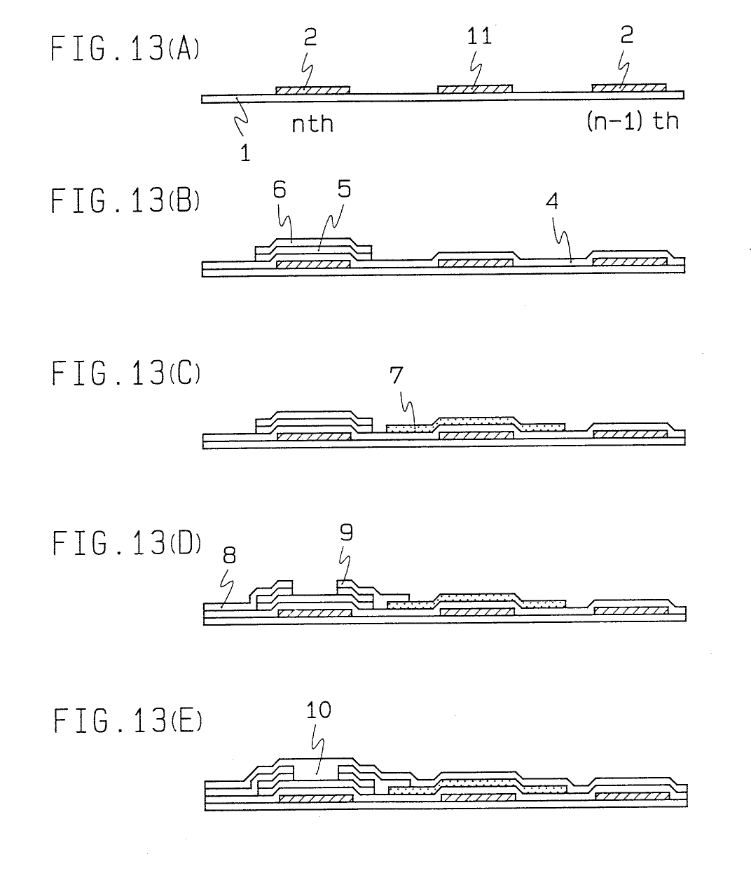

FIG. 14 is a plan view showing the conventional CS common line system TFT-LCD; and

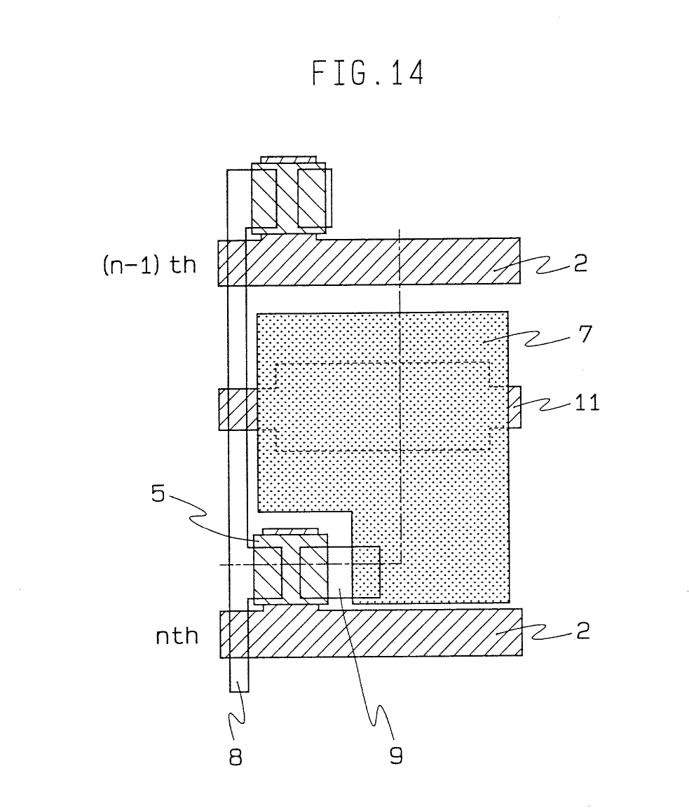

FIGS. 15(A) to 15(E) are each sectional view showing the method of manufacturing the conventional CS common line system TFT-LCD.

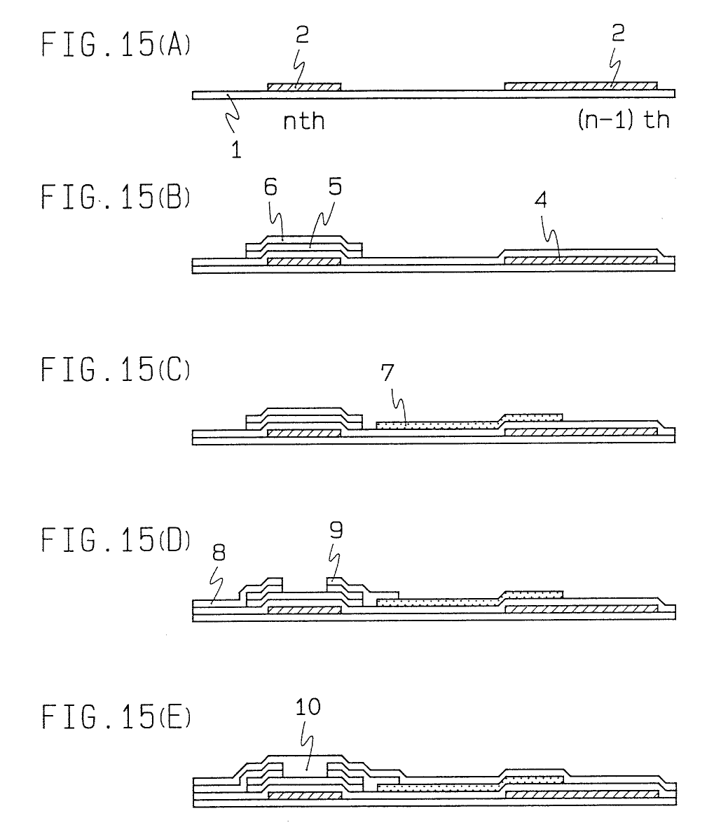

### DETAILED DESCRIPTION

### Embodiment 1

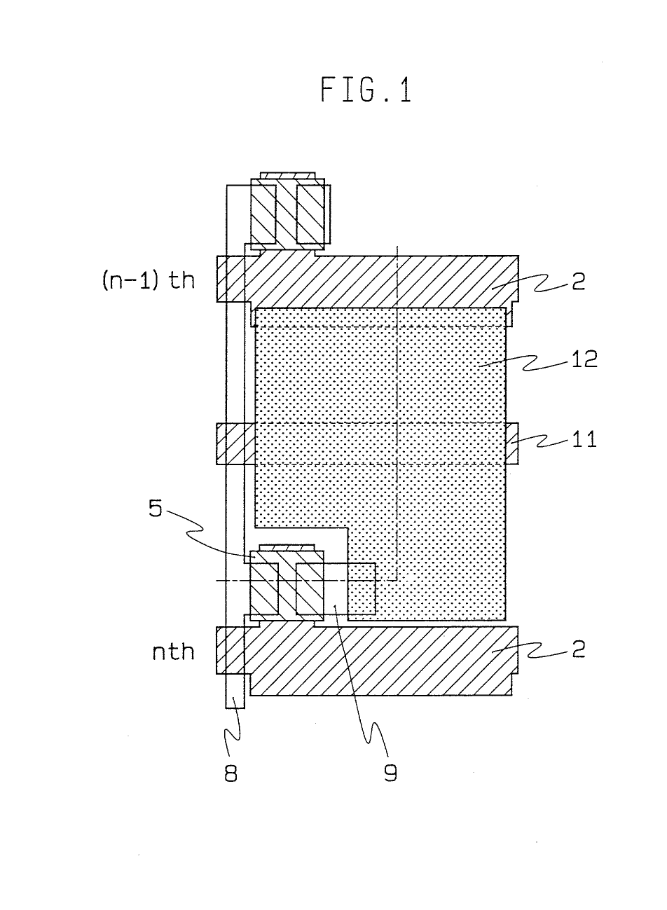

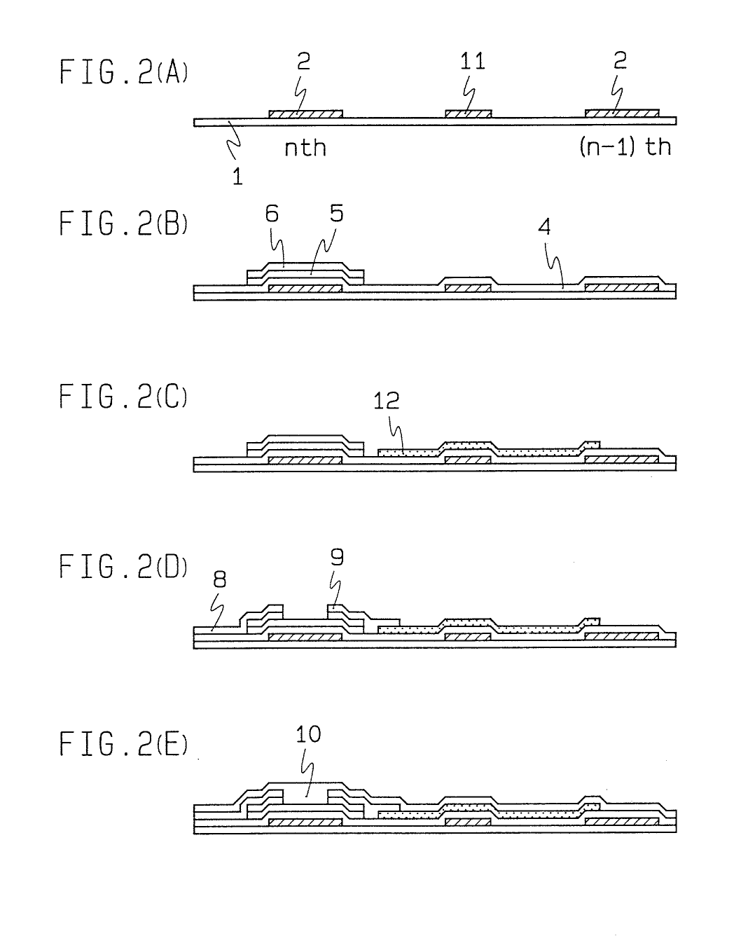

FIG. 1 is a plan view showing the TFT-LCD of channel etching type inverted stagger construction in Embodiment 1 of the present invention. FIG. 2 is a sectional view taken along a line of A-A′ showing the method of manufacturing the same.

Referring to the drawing, reference numerals 1 through 6, 8 through 11 are the same as the above described conventional apparatus, with no description of those being given. Reference numeral 12 is a pixel electrode, covers the common line 11 and also, superposes partially on the gate electrode 2 of one line before the line thereof.

The manufacturing method will be described hereinafter in accordance with FIG. 2.

The common line 11 is formed, on the glass substrate 1, at the same time with the gate electrode 2. The gate electrode 2 and the common line 11 are formed as thick in film as approximately 0.1 μm through 1.0 μm (see FIG. 2(A)) with the construction of opaque materials such as Al, Mo, Ta, Cu, Al—Cu, Al—Si—Cu, Ti, W or alloys among them or construction laminated with them.

Then, the gate insulating film 4, the amorphous silicon 5, the n+ amorphous silicon 6 with the P doped into it are successively deposited, and the amorphous silicon 5, the n+ amorphous silicon 6 with the P doped into it are removed by etching with the necessary portion remaining (FIG. 2(B)). Then, the pixel electrode 12 is formed to cover the common line 11 so as to superpose the gate electrode 2 (n-1st) of one line before the line of the gate electrode (FIG. 2(C)). Then, the source line 8 and the drain electrode 9 are formed. Then, the n+ amorphous silicon 6 with the P doped into it is removed with the portion necessary for forming the source region and the drain region of the TFT remaining (FIG. 2(D)). Finally, the passivation layer 10 is formed (FIG. 2(E)).

By the above described steps, the load capacity by Embodiment 1 can be formed with the common line 11 and at the same time, the TFT-LCD with the pixel electrode 12 being superposed with the gate electrode 2 of one line before the line thereof can be formed. In Embodiment 1, the most of the load capacitance necessary for the TFT-LCD can be formed with capacitance of the portion superposed between the common line 11 and the pixel electrode 12 can be formed. Therefore, the pixel electrode 12 and the gate electrode 2 of one line before the line of the electrode has only to shield the light leaked from the portion, and has only to be superposed at least. Thus, as the superposition between the pixel electrode 12 and the gate electrode 2 of one line before the line thereof can be made very small, the load capacitance of the gate electrode 2 is hardly increased. The width of the gate electrode becomes almost the same as in the CS-on-common structure and the gate electrode width increases so that the aperture ratio is not reduced. Accordingly, the TFT-LCD which is high in the aperture ratio and is small in the consumption power can be obtained, because the TFT-LCD in Embodiment 1 does not increase the load capacitance of the gate line and also, the space between the pixel electrode 12 and the gate electrode 2 of one line before the line thereof can be removed.

Also, in Embodiment 1, the TFT-LCD which does not change in cost, and is small in the consumption power can be obtained, because the conventional manufacturing process is not changed at all.

Also, although the structure example of the TFT of the channel etching type inverted stagger structure as the TFT construction, even the etching stopper type inverted stagger structure TFT for forming the passivation layer on the channel region has the same effect, with the effect being the same even in the following examples.

### Embodiment 2

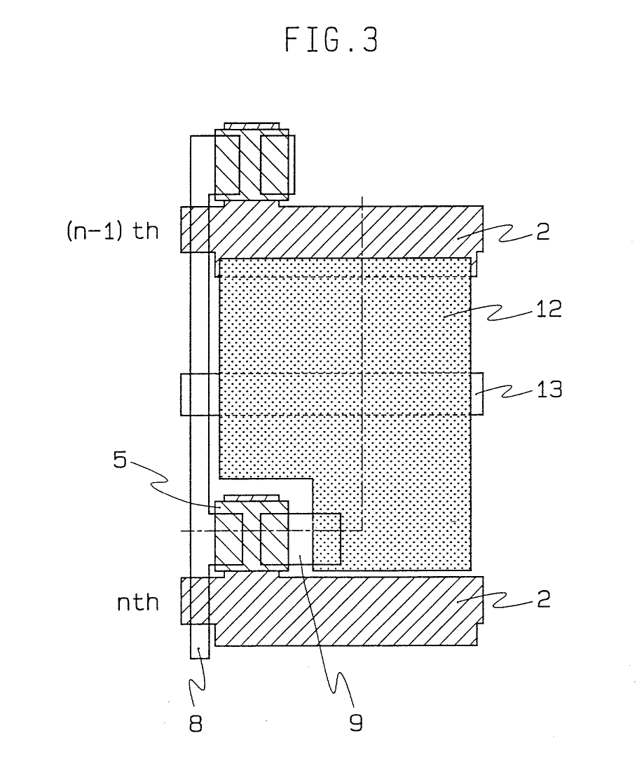

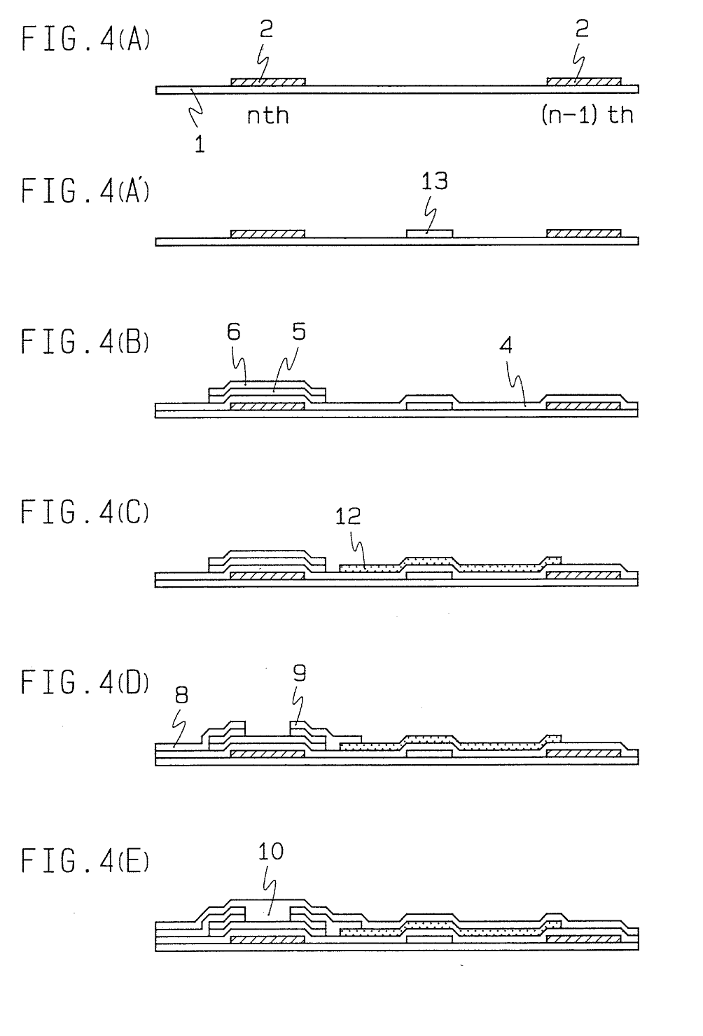

FIG. 3 is a plan view showing the TFT-LCD in Embodiment 2 of the present invention. FIG. 4 is a sectional view taken along a line of A-A′ showing the manufacturing method. Referring to the drawing, reference numerals 1 through 6, 8 through 10, reference numeral 12 are the same as in the above described conventional apparatus 1, with no description of those being given. Reference numeral 13 is a common line formed of a transparent material.

The manufacturing method will be described hereinafter in accordance with FIG. 4.

The gate electrode 2 is formed on the glass substrate 1. The gate electrode 2 is formed of as thick in film as approximately 0.1 μm through 1.0 μm (see FIG. 4(A)) with the construction of opaque material such as Cr, Al, Mo, Ta, Cu, Al—Cu, Al—Si—Cu, Ti, W or alloys among them or construction laminated with them. Also, the transparent electrode for covering the common line 13 is made of a material of 50% or more in transmittance with respect to the visual light such as ITO (indium tin oxide), tin oxide, indium phosphorus or the like, 500μΩ·cm or lower in specific resistance (FIG. 4(A′)).

The following manufacturing steps are the same as those of Embodiment 1.

The load capacitance by Embodiment 2 can be formed by the common line 13 by the above described steps and at the same time, the TFT-LCD can be formed with the pixel electrode 12 being superposed with the gate electrode 2 of one line before the line thereof. In Embodiment 2, the most of the load capacitance necessary for the TFT-LCD can be formed with capacitance of the portion superposed between the common line 13 and the pixel electrode 12, because the common line 13 is formed in the shape the same as in Embodiment 1. Therefore, the pixel electrode 12 and the gate electrode 2 of one line before the line thereof have only to shield the light leaked from the portion, and have only to be supposed at least. Thus, as the superposition between the pixel electrode 12 and the gate electrode 2 of one line before the line thereof is made very small, the load capacitance of the gate electrode is hardly increased. The width of the gate electrode becomes almost the same as in the CS-on-common structure and the gate electrode width increases so that the aperture ratio is not reduced. In Embodiment 2, the aperture ratio higher than in Embodiment 1 is obtained without the reduction in the aperture ratio reduction in the common line portion, because a transparent and conductive material is used for the common line. In Embodiment 2, the same effect can be obtained if the order is reverse although the common line 13 is formed after the formation of the gate electrode 2.

### Embodiment 3

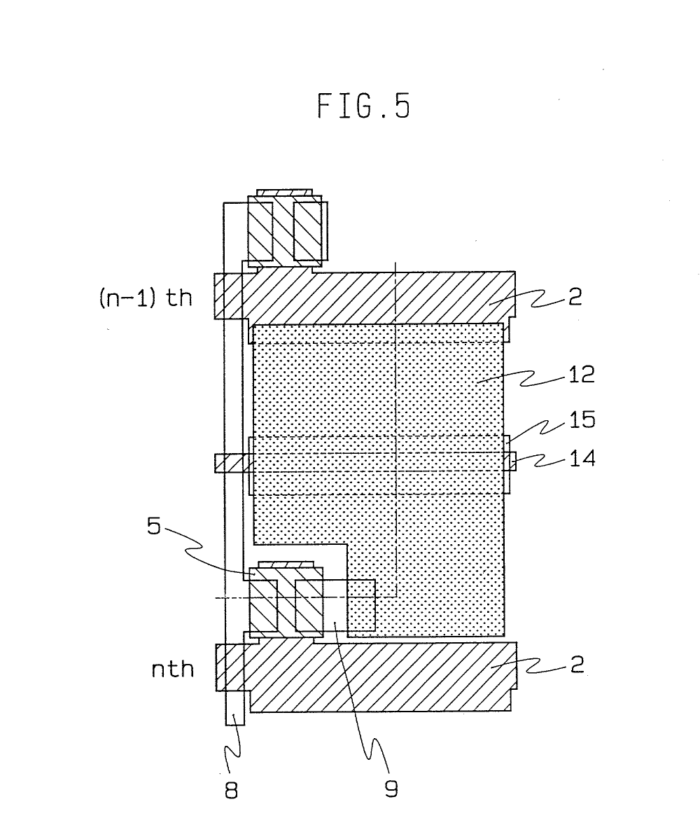

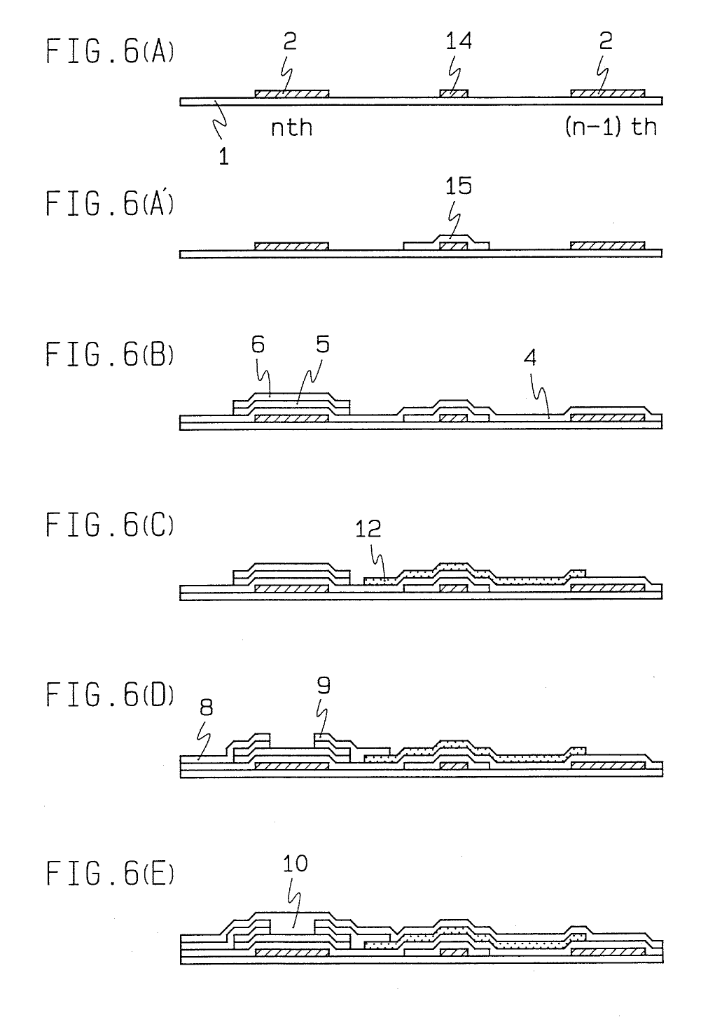

FIG. 5 is a plan view showing the TFT-LCD in Embodiment 3 of the present invention. FIG. 6 is a sectional view taken along a line of A-A′ showing the manufacturing method. Referring to the drawing, reference numerals 1 through 6, 8 through 10, reference numeral 12 are the same as in the above described conventional apparatus 1 with no description of those being given.

Reference numeral 14 is a common line formed of an opaque material. Reference numeral 15 is a transparent electrode formed to cover the common line 14.

The manufacturing method will be described hereinafter in accordance with FIG. 6.

The gate electrode 2 and the common line 14 are formed on the glass substrate 1. The gate electrode 2 and the common line 14 are formed of as thick in film as approximately 0.1 μm through 1.0 μm in film (see FIG. 6(A)) with the construction of opaque materials such as Cr, Al, Mo, Ta, Cu, Al—Cu, Al—Si—Cu, Ti, W or alloys among them or construction laminated with them. Then, the transparent electrode 15 for covering the common line 14 is made of a material of 50% or more in transmittance with respect to the visual light such as ITO (indium tin oxide, tin oxide, indium phosphorus or the like), 500μΩ·cm or lower in specific resistance (FIG. 6(A′)). The following manufacturing steps are the same as those of Embodiment 1.

The load capacitance in Embodiment 3 can be formed with the common line 14 by the above described steps, and at the same time, the TFT-LCD can be formed with the pixel electrode 12 being superposed with the gate electrode 2 of one line before the line thereof. In Embodiment 3 , the most of the load capacitance necessary for the TFT-LCD can be formed with capacitance of the portion superposed between the common line 14 and the pixel electrode 12, because the common line 14 is formed as in Embodiment 1. Therefore, the pixel electrode 12 and the gate electrode 2 of one line before the line thereof have only to shield the light leaked from the portion, and have only to be superposed at least. Thus, as the superposition between the pixel electrode 12 and the gate electrode 2 of one line before the line thereof is made very small, the load capacitance of the gate electrode is hardly increased. The width of the gate electrode 2 becomes almost the same as in the CS-on-common structure and the gate electrode width increases so that the aperture ratio is not reduced.

Further, by the combination between the common line 14 and the transparent electrode 15, the resistance value to be demanded by the common line 14 is obtained by the common line 14 and the area necessary as the load capacitance can be formed by the transparent electrode 15. The aperture ratio can be improved, because the load capacitance value necessary can be obtained while the width of the common line 14 is being narrowed.

### Embodiment 4

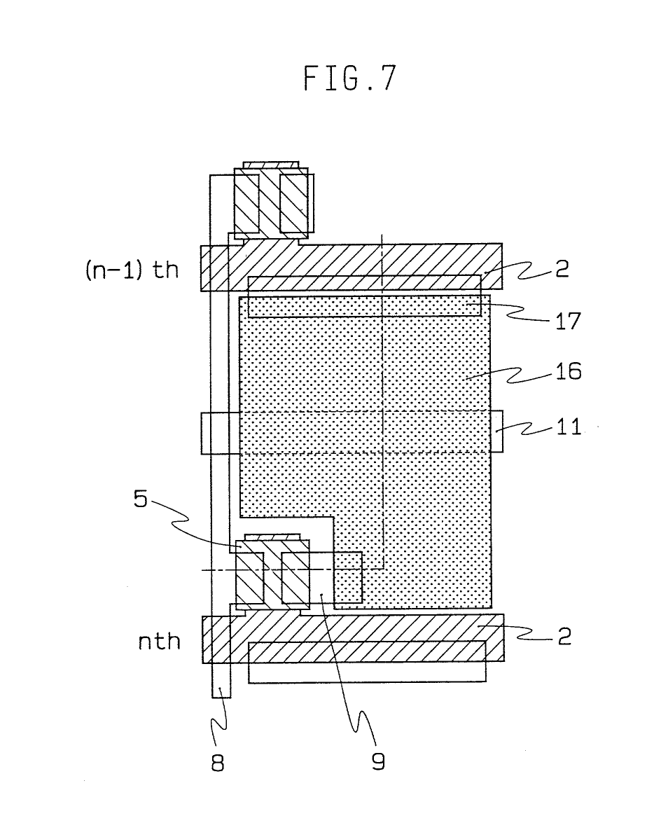

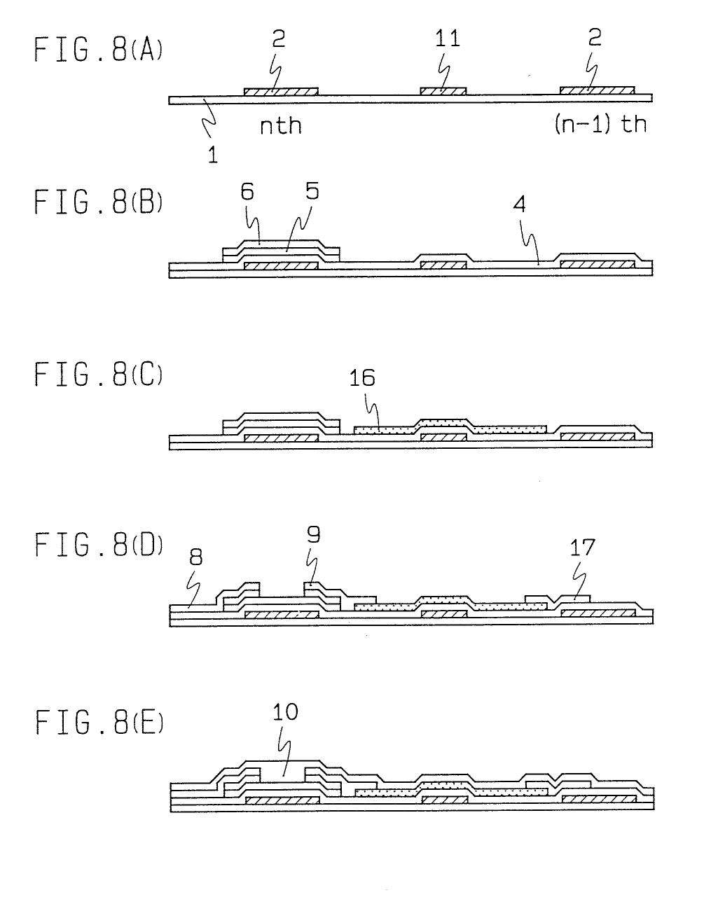

FIG. 7 is a plan view showing the TFT-LCD in Embodiment 4 of the present invention. FIG. 8 is a sectional view taken along a line A-A′ showing the manufacturing method. Referring to the drawing, reference numerals 1 through 6, 8 through 12 are the same as in Embodiment 1 with no description of those being given. Reference numeral 16 is a pixel electrode formed to cover the common line 11, and not superposed with respect to the gate electrode of n-1st gate electrode. Reference numeral 17 is an electrode for capacitance formed which is connected with the pixel electrode 16 and formed to be superposed with the n-1st gate electrode 2.

The manufacturing method will be described hereinafter in accordance with the manufacturing method. The steps of FIG. 8(A), FIG. 8(B) are the same as in Embodiment 1 with no description thereof being given. After the steps of FIG. 8(A), FIG. 8(B), the pixel electrode 16 can be formed only to cover the common line 11 (FIG. 8(C)). Although the source line 8 and the drain line 9 are formed, the pixel electrode 16 is connected at this time and the electrode 17 for capacitance is formed to be superposed with the n-1st gate electrode line 2. Thus, the capacitance between the n-1st gate electrode 2 and the pixel electrode 16 is formed. The following steps (FIG. 8(D)), (FIG. 8(E)) are the same as in Embodiment 1.

The load capacitance by the present invention is formed by the common line 11 by the above described steps, and also, the TFT-LCD can be formed with the gate electrode 2 of one line before the line thereof being superposed on the pixel electrode 16 by the above described steps. The gate electrode width is not necessary to be increased.

### Embodiment 5

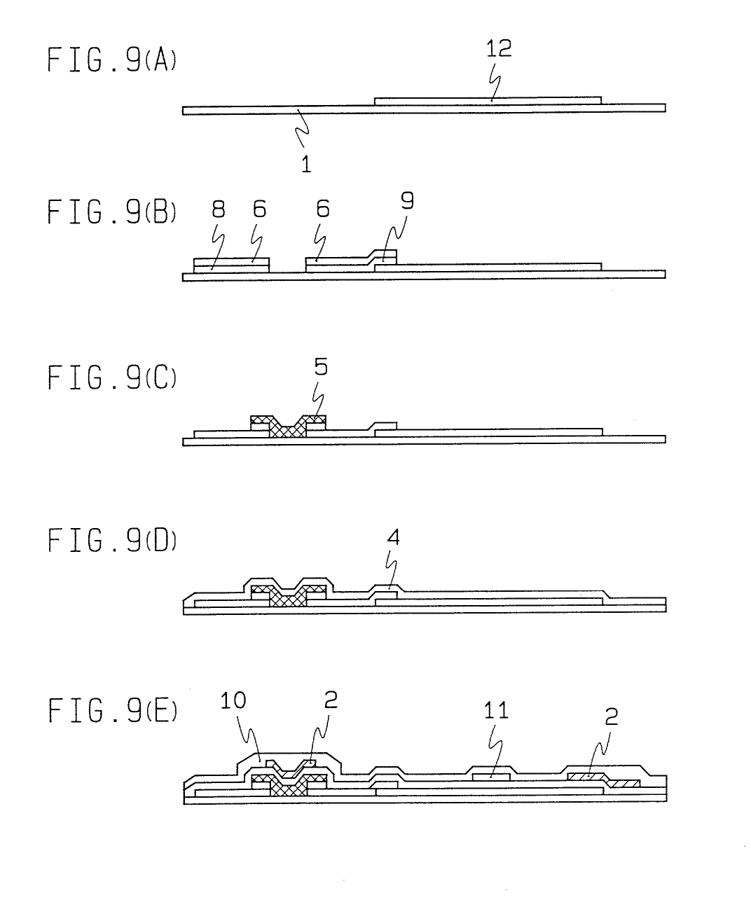

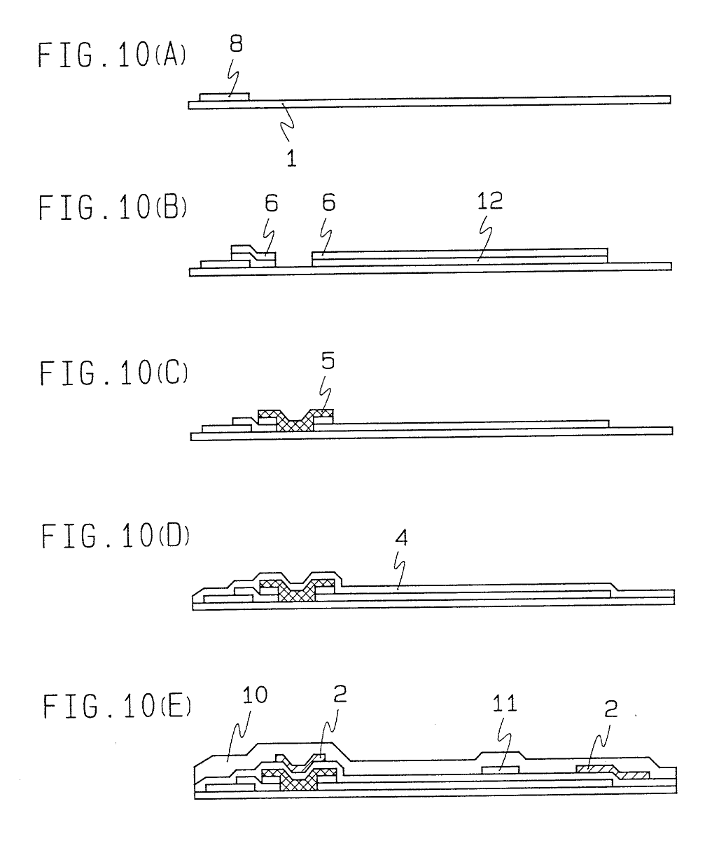

FIG. 9 and FIG. 10 are sectional views each showing the method of manufacturing the TFT-LCD of the normal stagger structure in Embodiment 5 of the present invention. Embodiment 5 is reversed vertically with the gate electrode 2 being formed upwards from the source/drain region 6, where the common line 11 and the pixel electrode 12 are superposed as in Embodiment 1, and one portion of the pixel electrode 12 and the n-1st gate electrode 2 are formed to be superposed. FIG. 9 is structure where the drain electrode 9 and the pixel electrode 12 are connected with each other. FIG. 10 shows the method of manufacturing the structure where the drain electrode is jointly used with the pixel electrode.

A method of manufacturing the TFT-LCD of FIG. 9 will be described hereinafter.

The pixel electrode 2 is formed on the glass substrate 1 (FIG. 9(A)). Then, the source line 8 and the drain electrode 9 are formed to be superposed on the pixel electrode 12 in the one portion of the drain electrode 9. The n+ amorphous silicon 6 is deposited on it to form the source drain region in a given shape (FIG. 9(B)). Then, the amorphous silicon 5 is deposited on the n+ amorphous silicon 6 and the glass substrate 1 (FIG. 9(C)). Then, after the gate insulating film 4 is formed on the entire (FIG. 9(D)), the common line 11 is formed on the pixel electrode 12 trough the gate insulating film 4, also the gate electrode 2 is formed on the amorphous silicon 5 and partially superposed on the pixel electrode 12, and the passivation layer 10 is formed on the entire face (FIG. 9(E)).

Then, the method of manufacturing the TFT-LCD of FIG. 10 will be described.

The source line 8 is formed on the glass substrate 1 (FIG. 10(A)). Then, the pixel electrode 12 is formed on the glass substrate 1, the n+ amorphous silicon 6 is deposited on the pixel electrode 12 and the source electrode 8 to form the source drain region in a given shape (FIG. 10(B)). The steps of FIG. 10(C) a through (E) are the same as the steps of FIG. 9(C) through (E).

The same effect is provided as in Embodiment 1 even in the TFT-LCD of the construction.

Also, it is needless to say that the construction can be made one of Embodiment 2 through 4 even in Embodiment 5.

### Embodiment 6

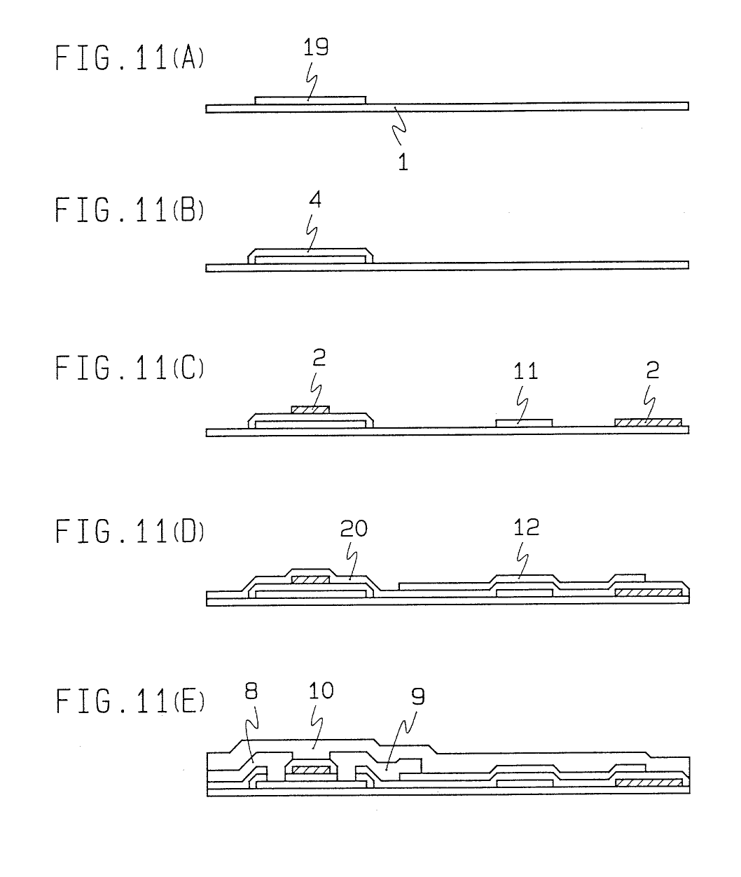

FIG. 11 is a sectional view showing a method of manufacturing the TFT-LCD of coplanar type construction in Embodiment 6 of the present invention. Reference numeral 19 is a polycrystalline silicon with source drain region being partially formed. Reference numeral 20 is insulating film deposited on the entire face including the gate electrode 2 and the common line 11. In Embodiment 6, the gate electrode 2 is formed on the source drain region, and the pixel electrode 12 is formed to cover the common line 11 and to be superposed partially on the gate electrode 2.

The manufacturing method will be described hereinafter in accordance with FIG. 11. Polycrystalline silicon 19 is deposited on the glass substrate 1 (FIG. 11(A)). Then, the polycrystalline silicon 19 is thermally oxidized to form the gate insulating film 4 (FIG. 11(B)). The gate electrode 2 and the common line 11 are formed on polycrystalline silicon 19 and the glass substrate 1 (FIG. 11(C)).

After the insulating film 20 being deposited on the entire face, the common line 11 is covered through the insulating film 20 and the pixel electrode 12 is partially superposed on the gate electrode 2 (FIG. 11(D)). Then, after the formation of the source line 8 and the drain electrode 9, the passivation layer 10 is formed across the entire face (FIG. 11(E)).

Even in the TFT-LCD of the construction, the same effect as in Embodiment 1 is provided.

Also, it is needless to say that even in this Embodiment, the construction can be made as in Embodiment 2 through Embodiment 4.

Either of films SiN, SiO₂, Ta oxide, Ti oxide, Al oxide, Cr oxide or films laminated with them may be used as gate insulating film in the above described Embodiment 1 through Embodiment 6.

Not only amorphous silicon, but also polycrystalline silicon and Cd—Se are the same as semiconductor material for forming TFT.

The present invention is composed as described above so that such effects as described above are provided.

The liquid crystal display of the preset invention is provided with common line for auxiliary capacitance arranged among a plurality of gate electrodes formed on the insulating substrate and the adjacent gate electrodes, at least one layer of semiconductor material film to be formed to cover at least one portion of the gate electrode through the gate insulating film formed on the insulating substrate, a source region and a drain region formed in the semiconductor material film, a pixel electrode formed on the gate insulating film and formed to cover the common line, an electrode for capacitance to be connected with the pixel electrode and formed to superpose one portion on the adjacent gate electrode, a source electrode and a drain electrode provided respectively on the source region and the drain region.

As the capacitance is obtained by the superposition between the pixel electrode and the common line, the superposition between the electrode for capacitance and the adjacent gate electrode can be made smaller. Therefore, the delay time of the gate signals can be made shorter without increase in the load capacitance of the gate electrode.

Further, as the electrode for capacitance is an extension of the pixel electrode, the space between the pixel electrode and the adjacent gate electrode can be removed so that the aperture ratio can be made higher and the consumption power can be made smaller.

Further, higher aperture ratio can be obtained without reduction of the aperture ratio in the common line portion, because transparent and conductive material is used for the common line.

The aperture ratio can be improved, because the necessary load capacitance value can be obtained by the transparent electrode while the width of the common line being narrowed, by the combination between the common line and the transparent electrode with the transparent electrode being provided in contact with the common line so as to cover the common line.

Also, a method of manufacturing a liquid crystal display apparatus of the present invention comprises a first step of forming a plurality of gate electrodes on the insulating substrate, a second step of forming the common line to be arranged between the adjacent gate electrodes, a third step of forming the gate insulating film on the insulating substrate including the on gate electrode and the on the common line, a fourth step of sequentially forming the semiconductor material film of at least one layer, a fifth step of covering the common line through the gate insulating film, and also forming the pixel electrode so that one portion may be superposed on the adjacent gate electrode, a sixth step for forming the source region and the drain region by etching the semiconductor material film.

Thus, the superposition between the pixel electrode and the gate electrode may be made smaller. Therefore, the liquid crystal display apparatus can be made where the delay time of the gate signal can be made shorter without increase in the load capacitance of the gate electrode, the aperture ratio is made higher and the a consumption power is made smaller.

Also, a seventh step of forming the transparent electrode so as to cover the common line is carried out before the third step after the completion of the second step. The aperture ratio can be improved, because the necessary load capacitance value can be obtained by the transparent electrode while the width of the common line being narrowed, by the combination between the common line and the transparent electrode.

While only certain presently preferred embodiments of the invention have been described in detail, as will be apparent with those familiar with the art, certain changes and modifications can be made without departing from the spirit and scope of the inventions defined by the following claims.

What is claimed is:

1. A liquid crystal display comprising an insulating substrate, a plurality of gate electrodes, a common line for auxiliary capacitance arranged between adjacent gate electrodes, said common line being formed on the insulating substrate and the adjacent gate electrodes, at least one layer of semiconductor material film formed so as to cover at least one portion of the gate electrodes through the gate insulating film formed on the insulating substrate, a source region and a drain region formed in the semiconductor material film, a pixel electrode formed on the gate insulating film and formed to cover the common line, an electrode for capacitance to be connected with the pixel electrode and formed to superpose one portion on the adjacent gate electrode, and a source and a drain electrode provided respectively on the source region and the drain region.

2. A liquid crystal display comprising an insulating substrate a pixel electrode formed on the insulating substrate, an electrode for capacitance connected with the pixel electrode, and at least one layer of semiconductor material layer, a source region and a drain region formed on the semiconductor material layer, a gate insulating film formed on the insulating substrate, and a common line for auxiliary capacitance arranged between the plurality of gate electrodes formed on the semiconductor material through the gate insulating film and the adjacent gate electrodes are provided, with the common line being arranged on the pixel electrode through the gate insulating film, and the electrode for capacitance is formed so as to superpose one portion on the adjacent gate electrode through the gate insulating film.

3. A liquid crystal display comprising an insulating substrate, a semiconductor material film having a source region and a drain region formed on the insulating substrate, a gate insulating film formed to cover the top face and the side face of the semiconductor material film, a plurality of gate electrodes formed on the insulating substrate including the gate insulating film, a common line for auxiliary capacitance to be formed on the insulating substrate and arranged between the adjacent gate electrodes, an insulating film formed on an insulating substrate including the on gate insulating film, the on gate electrode and the on the common line, a pixel electrode to be formed on the insulating film and formed to cover the common line, an electrode for capacitance to be formed on the insulating film and formed, and to be connected with the pixel electrode and formed to superpose one portion on the adjacent gate electrode.

4. The liquid crystal display of claim 1, wherein the electrode for capacitance is extending of the pixel electrode.

5. The liquid crystal display of claim 1, wherein gate electrode and the common line are made of the same material.

6. The liquid crystal display of claim 1, wherein the common line is made of a transparent material.

7. The liquid crystal display of claim 6, wherein the transparent material of the common line is made of a material which is 50% or more in transmission factor with respect to visual light and 500μΩ·cm or lower in specific resistance.

8. The liquid crystal display of claim 7, wherein the transparent material of the common line is made of either of indium tin oxide, tin oxide, indium phosphorus.

9. The liquid crystal display of claim 1, wherein the transparent electrode is provided to cover the common line in contact with common line.

10. The liquid crystal display of claim 9, wherein the transparent electrode for covering the common line is made of a material of 50% or more in transmission factor with respect to the visual light, 500μΩ·cm or lower in specific resistance.

11. The liquid crystal display of claim 9, wherein the transparent material for covering the common line is made of either of indium tin oxide, tin oxide, indium phosphorus.

12. The liquid crystal display of claim 1, wherein the semiconductor material film is amorphous silicon film.

13. The liquid crystal display of claim 1, wherein the semiconductor material film is polycrystalline silicon film.

14. A method of manufacturing a liquid crystal display comprising a first step of forming a plurality of gate electrodes on the insulating substrate, a second step for forming the common line to be arranged between the adjacent gate electrodes, a third step of forming the gate insulating film on the insulating substrate including the on the gate electrode and the on the common line, a fourth step for forming the semiconductor material film of at least one layer, a fifth step of covering the common line through the gate insulating film, and also forming the pixel electrode so that one portion may be superposed on the adjacent gage electrode, a sixth step for forming the source region and the drain region by etching the semiconductor material film.

15. The method of claim 14, wherein the first step and the second step are carried out at the same time.

16. The method of claim 14, wherein the method including a seventh step of forming the transparent electrode so as to cover the common line.

17. The method of claim 14, wherein the seventh step is carried out before the third step after the completion of the second step.
